(19) United States
(12) Patent Application Publication
(10) Pub. No.: US 2023/0340683 A1
(43) Pub. Date: Oct. 26, 2023

(54) MEANS AND METHOD OF MENISCUS CONFINED ELECTROCHEMICAL DEPOSITION WITH ACCURATE MEANS OF IN SITU THICKNESS ASSESSMENT

(71) Applicant: MINIXA LTD., Jerusalem (IL)

(72) Inventors: Eran OREN, Tel Aviv (IL); Nadav MANSDORF, Jerusalem (IL)

(21) Appl. No.: 18/043,805

(22) PCT Filed: Sep. 5, 2021
(86) PCT No.: PCT/IL2021/051092

§ 371 Date: Mar. 2, 2023

Related U.S. Application Data
(60) Provisional application No. 63/075,155, filed on Sep. 6, 2020.

(51) Int. Cl. C25D 1/00; C25D 21/12; C25D 21/02; B33Y 50/02; B33Y 70/00; B33Y 30/00; B28B 1/00; B28B 17/00; B33Y 10/00; B22F 12/90; B22F 12/53; B22F 10/85

(52) U.S. Cl. CPC C25D 1/003; C25D 21/12; C25D 21/02; B33Y 50/02; B33Y 70/00; B33Y 30/00; B28B 1/001; B28B 17/0081; B33Y 10/00; B22F 12/90; B22F 12/53; B22F 10/85

(57) ABSTRACT

The present invention discloses a system for 3D printing by using meniscus-confined electrodeposition, using at least one pipette, carrying at least one electrolyte, at least one means of thickness or deposition rate assessment and at least one motion control mechanism, configured to allow the deposition of at least one deposited metal on a substrate. The invention also discloses a method of 3D printing, characterized by one or more steps of meniscus-confined electrodepositing, using at least one pipette, carrying at least one electrolyte, utilizing at least one means of thickness or deposition rate assessment and at least one motion control mechanism, thereby enabling the deposing of at least one deposited metal on a substrate.

### FIELD OF THE INVENTION

The invention herein relates generally to the field of 3D printing and additive manufacturing. More specifically, it relates to electrochemical means and electrodeposition methods for the purpose of additive manufacturing. The invention further pertains to means and method of meniscus confined electrochemical deposition with accurate means of in situ thickness assessment.

### BACKGROUND OF THE INVENTION

Prior art has taught the use of electrodeposition of metals and other materials in a variety of embodiments. For example, [1-3] teach methods and apparatuses for 3D printing using electrochemical based metal deposition, thus allowing a variety of materials to be printed. Among the advantages of electrochemical deposition are the use of metals in manufacturing accurately controlled surfaces, with almost no limitation as to the potential accuracy and resolution levels. Prior art has further taught the utilization of said potential accuracy by the introduction of meniscus confined electrodeposition ([4-6]). The publications taught the use of a moving component creating a relatively small meniscus of an electrolyte that upon application of voltages and currents causes deposition at a desired point. Said art has shown the need for accurate measurement of the amount of the deposited materials by introducing an Atomic Force Microscope (AFM) that uses an accurately shaped and manufactured tip, the deflection thereof is measured using some measuring device. AFM devices thus allow monitoring of a deposited surface up to sub-nanometer accuracies.

However, prior art is limited in many ways due to the high prices and complexity of AFM and its tips, as well as the susceptibility to damage by potential electrolytes that may be corrosive or hazardous. In addition, the indirect measurement of deflection forces causes undesired effects such as the detection of changes in the fluid weight. It can then render fast pumping of the required electrolyte harder or impossible due to tip deflection. Furthermore, while sub-nanometer resolutions are required for some exotic applications, lower resolutions at the micrometer range or near it are useful for a wider variety of needs, and yet are not answered by existing 3-dimensional additive manufacturing techniques of metals ([7-10]).

It can be further shown that the need for micron-scale metal additive manufacturing and 3D printing remains unmet by a variety of techniques shown recently in the art using a variety of physical and chemical mechanisms to deposit metals in such scales. Among others, [17] shows the use of 2-photon polymerization of plastic materials that are loaded with metallic nano particles to achieve composite materials; [18] shows the use of charged aerosol jets in a vacuum chamber to achieve accurate deposition of metals ions; [19] shows the use of a focused ion beam for the deposition of micro and nano structures with varying thicknesses. However, while the myriad of publications shows the need and interest in such technologies, the solutions are generally reliant on high vacuum systems, extreme high voltage and other equipment limited by capital needs, and operation expertise. Furthermore, limitations on materials printed and on shapes prohibits mentioned technologies and others in wide applications of micro 3D printing. There is thus an unmet need for cost effective 3D printing of metals in the micron resolution range.

### SUMMARY OF THE INVENTION

It is hence an object of the invention to disclose means (system, subsystems and modules thereof) and method of meniscus confined electrochemical deposition with accurate means of in situ thickness assessment. The invention discloses a system for 3D printing by using meniscus-confined electrodeposition, using at least one pipette, carrying at least one electrolyte, at least one means of thickness or deposition rate assessment and at least one motion control mechanism, configured to allow the deposition of at least one deposited metal on a substrate.

It is another object of the invention to disclose the system as defined above, wherein the deposition rate assessment includes at least one transmitter and at least one receiver. Additionally, or alternatively, the transmitter is a light source such as a laser or a laser diode and the receiver is an optical sensor such as at least one photodiode or at least one CCD. Additionally, or alternatively, the thickness or deposition rate assessment is performed by means of astigmatism correction. Additionally, or alternatively, the thickness or deposition rate assessment is performed by means of interferometry. Additionally, or alternatively, the thickness or deposition rate assessment is performed by means of angle change measurement. Additionally, or alternatively, the thickness or deposition rate assessment is performed by means of time-of-flight measurement. Additionally, or alternatively, the transmitting component is set in such a way that the deposited metal creates a shadow that is detected by the receiving component. Additionally, or alternatively, the transmitter and the receiver are set on the same side or within the same mechanical component. Additionally, or alternatively, the means for thickness or deposition rate assessment is a capacitive distance transducer. Additionally, or alternatively, the means for thickness or deposition rate assessment is an inductive distance transducer. Additionally, or alternatively, means for thickness or deposition rate assessment is an ultrasound transducer. Additionally, or alternatively, the deposition rate assessment mechanism is a contact sensor, that can be embedded in the at least one pipette. Additionally, or alternatively, deposition rate assessment mechanism is a vibration sensor. Additionally, or alternatively, the vibration sensor utilizes forced vibration that are affected by the deposited material. Additionally, or alternatively, the means for thickness or deposition rate assessment is a quartz crystal microbalance (QCM). Additionally, or alternatively, the means for thickness or deposition rate assessment is an electrical measurement of resistance or impedance in at least one frequency. Additionally, or alternatively, the means for thickness or deposition rate assessment is an optical, infra-red, near-infra-red, short-wave-infra-red or an ultra-violet detector. It is another object of the invention to disclose the system as defined in any of the above, wherein at least one additional material is added to the electrolyte for increased signal from the disclosed means for thickness or deposition rate assessment. Additionally, or alternatively, the added material is a dye to increase optical or another electromagnetics contrast. Additionally, or alternatively, the added material is a fluorescent material. Additionally, or alternatively, a microscope or a stereoscopic microscope is also used in combination with the combination of the sensors therein. Additionally, or alternatively, the signal acquired by the at least one means for thickness or deposition rate assessment is utilized by a computer controller for prediction or assessment thereof. Additionally, or alternatively, the at least one means of thickness or deposition rate assessment is a computer controller, typically calibrated by data acquired by means described in any of the above. Additionally, or alternatively, the computer controller applies a neural network for the deposition rate assessment. Additionally, or alternatively, the deposition rate assessment is performed without additional sensors in the printing process. Additionally, or alternatively, at least some component of memory, data or computation is performed over a remote computer such as in “cloud computing” architecture. Additionally, or alternatively, signals or information regarding deposition rate is transmitted to said remote computer through some communications channel such as IP protocol. Additionally, or alternatively, at least a part of the system is held internally in an environment sealed to its surroundings, typically utilizing at least one means of temperature, humidity or pressure control; potential contained overpressure to prevent entry of polluting agents or dirt or potential contained under pressure to prevent leakage of toxic or corrosive materials to the outside; and means for monitoring the internal processes and conditions. Additionally, or alternatively, one wall of the sealed environment is flexible to allow the at least one motion control mechanism to move while containing a part of the system sealed. Additionally, or alternatively, temperature control is applied using also at least one phase change material (PCM). Additionally, or alternatively, temperature and humidity control are performed through a device in physical contact with the at least one pipette. Additionally, or alternatively, sealed environment is at least partially filled with liquid for the prevention of pipette droplets or meniscus evaporation. Additionally, or alternatively, the at least one pipette is a hollow, typically tapered pipe made of glass, plastic, ceramics, metals, alloys or other materials, allowing electrolyte flow towards an orifice of typical diameters of about 0.25 to about 50 micrometers, and typically containing at least one electrode in it. The term “about” refers hereinafter to any measure being greater than or smaller than up to 20% of the defined value. Additionally, or alternatively, the system is as defined in any of the above, and instead of a tapered shape, the pipette has a thicker diameter along most of its length and a thin orifice at its end. Additionally, or alternatively, the thin orifice is laser drilled, chemically etched, plasma etched or mechanical imprinted to have said diameters. Additionally, or alternatively, the pipette is composed of at least two parts, one of which is a cap, typically including the described orifice. Additionally, or alternatively, the at least two components are connected together by means of chemical adherence, physical adherence, welding, laser welding, electron beam welding, mechanical shrink-fitting or others. Additionally, or alternatively, the orifice is asymmetrically placed at the side of an otherwise symmetrical pipette. Additionally, or alternatively, the pipette itself is asymmetrical. Additionally, or alternatively, the pipette or pipettes are tilted to allow the action of the thickness or deposition rate assessment as defined in any of the above. Additionally, or alternatively, the pipettes are coated or otherwise surface treated to be more hydrophobic or more hydrophilic. Additionally, or alternatively, multiple pipettes are used to deposit the same material. Additionally, or alternatively, multiple pipettes are used to deposit different materials. Additionally, or alternatively, at least one valve or computer-controlled valve is used to control the flow into at least one pipette. Additionally, or alternatively, the at least one pipette has an embedded heating mechanism such as an electric heating element. Additionally, or alternatively, a mechanism is applied for introducing fresh ions into the electrolyte volume near the deposition location. Additionally, or alternatively, the mechanism for fresh ion introduction is a pump, such as a syringe pump, rotary pump, diaphragm pump or other. Additionally, or alternatively, a magnetic mixing mechanism is introduced as well or separately such as with magnetic beads and coils for the induction of magnetic fields. Additionally, or alternatively, the at least one motion control mechanism is a multiple degrees of freedom stage such as an X-Y-Z stage. Additionally, or alternatively, the three stages are mounted on each other. Additionally, or alternatively, on of the three stages is mounted separately, such as a separate height control for the pipette and a two-dimensional control for the substrate. Additionally, or alternatively, the motion control includes at least one tilting degree of freedom, such as controlling the angle of the pipette or the substrate in reference to the axis of gravity. Additionally, or alternatively, the motion control includes at least one rotary degree of freedom such as controlling the azimuth of the pipette or the substrate in reference to each other. Additionally, or alternatively, the motion control is performed through stepper motors. Additionally, or alternatively, the motion control is performed through piezoelectric motors. Additionally, or alternatively, the motion control is performed through piezo lever amplification (PLA) actuators. Additionally, or alternatively, the motion control utilizes some closed loop feedback such as strain gauges, encoders, any of the sensors described aboveor any combination thereof. Additionally, or alternatively, the system is used in conjunction with an asymmetric pipette as disclosed above. Additionally, or alternatively, multiple pipettes are controlled with separate motion controllers. Additionally, or alternatively, an accurate motion control mechanism is mounted on a less accurate motion control mechanism with a longer range of motion, thus allowing the combination of local high resolution and accuracy motion and large distances or volumes for printing. Additionally, or alternatively, the materials deposited are at least one or any combination of the following metals: Cu, Ni, Fe, Zn, Ag, Al, Au, Pt, Co, Pd, Sn, W, Mo, Ga, In or other elemental metals. Additionally, or alternatively, the materials deposited are at least one or any combination of the following alloys: NiTi, CoNiAl, CoNiGa, NiTiPd, CoNiGa, NdFeB, SmCo or other alloy materials. Additionally, or alternatively, the materials deposited are or are oxidized to be at least one or any combination of PZT, GaPO₄, PbTiO₃, LiNbO₃ or other ceramic materials. Additionally, or alternatively, at least one of the deposited materials serves as a ‘support’ material intended to be removed after the 3D printing process is over. Additionally, or alternatively, the support material is removed via a thermal process such as Gallium or Indium. Additionally, or alternatively, the support material is removed via a chemical process such as Zn or Al.

It is another object of the invention to disclose a method of 3D printing, characterized by one or more steps of meniscus-confined electrodepositing, using at least one pipette, carrying at least one electrolyte, utilizing at least one means of thickness or deposition rate assessment and at least one motion control mechanism, thereby enabling the deposing of at least one deposited metal on a substrate.

It is still another object of the invention to disclose a method of 3D printing, characterized by one or more steps of meniscus-confined electrodepositing, comprising steps of providing a system as defined in any of the above, and utilizing at least one means of thickness or deposition rate assessment and at least one motion control mechanism, thereby enabling the deposing of at least one deposited metal on a substrate.

It is another object of the invention to disclose the system as defined in any of the above, wherein the system utilizable for 3D printing by a method characterized by one or more steps of meniscus-confined electrodepositing, using at least one pipette, carrying at least one electrolyte, utilizing at least one means of thickness or deposition rate assessment and at least one motion control mechanism, thereby enabling the deposing of at least one deposited metal on a substrate.

### BRIEF DESCRIPTION OF THE DRAWINGS

Referring now to the drawings in which like reference numbers represent corresponding parts throughout:

FIG. 1 schematically illustrating a sealed system with a pipe going through a flexible side to allow deposition therein according to an embodiment of the invention;

FIG. 2 schematically illustrating a pipette tip with a sensor arrangement typical of optical laser sensing according to another embodiment of the invention;

FIG. 3 schematically illustrating a different embodiment showing a different orientation of sensor and pipette and potentially a different type of sensor according to another embodiment of the invention;

FIG. 4 schematically illustrating a different orientation of sensors and pipettes with at least one of each according to v embodiment of the invention;

FIG. 5 schematically illustrating a wide pipette tip with thick walls and small meniscus orifice according to another embodiment of the invention;

FIG. 6 schematically illustrating a pipette held inside a printing head that includes heating, cooling or temperature control means such as a phase change material according to another embodiment of the invention;

FIG. 7 schematically illustrating a thick pipette with meniscus hole oriented sideways for such applications as printing micro coils on a bobbin according to another embodiment of the invention; and,

FIG. 8 schematically illustrating system components and control diagram according to another embodiment of the invention.

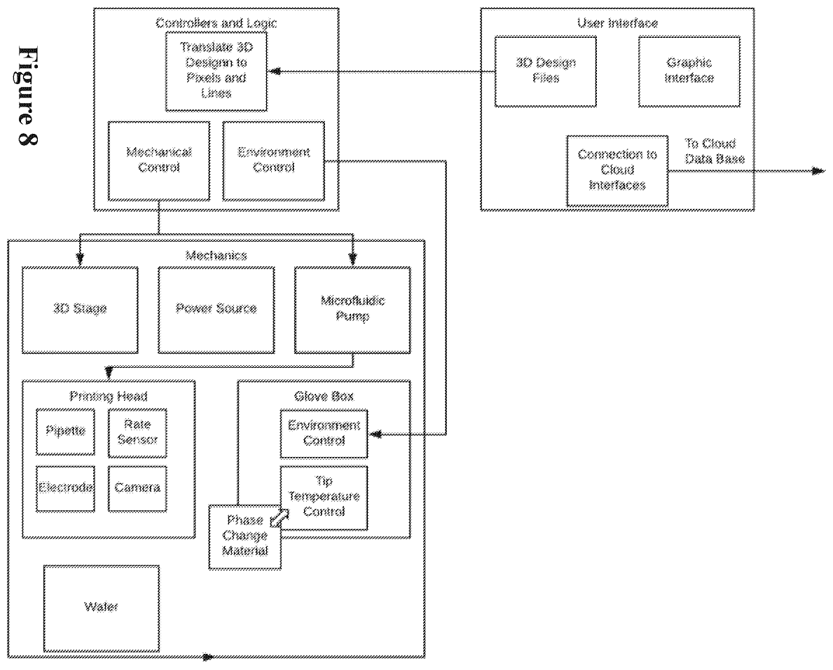

### DETAILED DESCRIPTION OF THE PREFERRED EMBODIMENTS

In the following description, reference is made to the accompanying drawings which form a part hereof and which illustrate several embodiments of the present invention. It is understood that other embodiments may be utilized and structural and operational changes may be made without departing from the scope of the present invention.

The invention described herein is a method for accurate three-dimensional printing (3D printing) in which very high resolutions are allowed by accurate control of a moving printing head. The addition of material to the printed result is performed by mechanisms of electrochemical material deposition (electrodeposition), and thus mainly reflect the ability to deposit metals or other conductive or semi-conductive materials by the use of an electrolyte in which ions or other charged particles are moving due to some externally controlled voltage and current.

In using a pipette or a pipette-like element, in which the electrolyte flows, the exiting droplet creates a meniscus, thus allowing for use of a meniscus-confined deposition (also referred to as ECAM for electrochemical additive manufacturing). In order to use the additive deposition as a 3D printer, control of at least 3 degrees of freedom is needed. The accurate control of two axes down to sub micrometer resolution is relatively straightforward by the use of accurate electric motors or piezoelectric based drives. However, the control of the deposition rate which translates in turn to the third axis is difficult due to the requirement of predicting or controlling the deposition rate which is affected by a multiplicity of environmental factors. Aforementioned prior art has shown trials to counter this uncertainty by the use of an Atomic Force Microscopy (AFM) or AFM like device, which measures the pipette deflection with a highly sensitive spring and an optical sensing mechanism, thus detecting motion down to the nanometer range or below it ([5-6]). However, AFM tips are expensive components that typically provide nanometer range resolution, not needed for many micron-range applications. Furthermore, characteristic prices of AFM tips and the components for deflection measurement are such that they de-facto prevent the use of corrosive materials such as ionic liquids in close proximity with them.

To overcome said limitations of AFM based solutions, the invention herein uses at least one other mechanism for control over the uncertainty in deposition rate. In the preferred embodiment, this mechanism is at least one sensor that reads the deposited height or thickness of the added material. The following examples are intended to provide realistic examples of a variety of technological and physical options to measure and monitor the electrodeposition process.

The invention described herein hence discloses a method of 3D printing by using meniscus-confined electrodeposition, in which micrometer and sub-micrometer resolutions can be achieved, yet overall price and complexity are kept low. While aforementioned prior art uses extremely complex machinery such as atomic force microscopy and microfluidic channels to control deposition rate and fluid motion, the invention herein includes the use of at least one deposition rate assessment unit that is comprised of such means, yet is not limited to, thickness sensors based on laser measurement, interferometric or astigmatism measurement, ultrasonic transducers, capacitive or inductive measurement, contact measurement, vibration monitors, computerized rate prediction or other. The real-time or near real-time monitoring of the deposited thickness allows for high-resolution printing without the need for expensive apparatuses such as shown by related art. In some embodiments, the measurements are used to calibrate the deposition rate in such a way that allows predicting it without measuring in real time.

The use of simple or no measurement tools allows the application of simple systems that include a 2D or 3D motorized stages, a glovebox or other means of environmental confinement, and thus the use of accurate temperature control and hazardous materials. Among others, this means that 3D printing can be done in a quicker fashion, and with extended use of such hazardous or corrosive materials as ionic liquids or molten salts. Such advances allow the printing of metals, alloys, composites or semiconductors otherwise impossible to electrodeposit, and can be applied in fields of medicine, electronics, microelectronics, micromechanics, sensing applications and others.

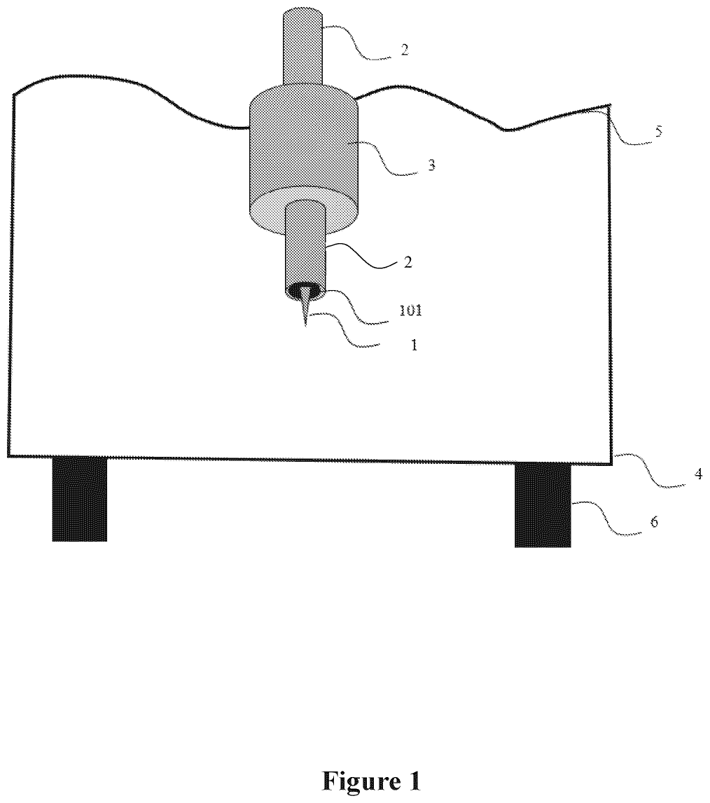

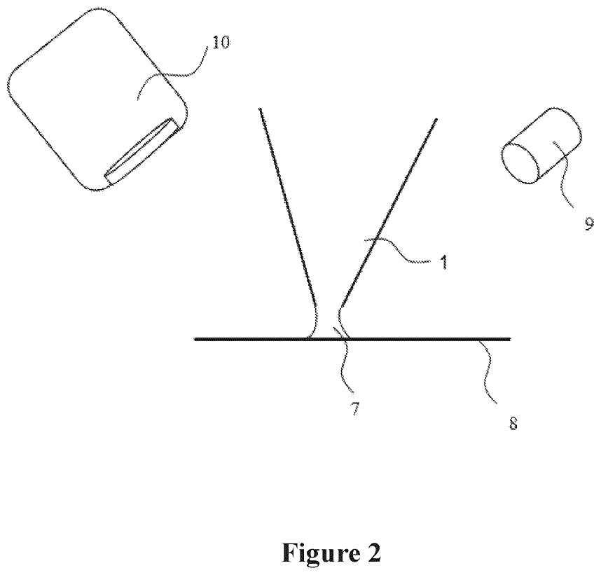

In the preferred embodiment, a pipette (FIG. 1, 1) is connected with a fluid flow system (2), typically made of pipes or flexible pipes and hoses. Said pipes and connections typically lead to an electrolyte reservoir (not depicted), and potentially utilizing valves and other flow control means along them. A pump (not depicted) is typically used for the motion of an electrolyte towards the pipette. Once an electrolyte reaches the pipette orifice, it creates a droplet, meaning a liquid hanging from the end of the pipette, or a meniscus (FIG. 2, 7), meaning a liquid constrained from two sides by the pipette (1) and a bottom plate (FIG. 2, 8).

In some embodiments, the contraption is held at least in part in a closed or a sealed environment for purposes of maintaining known and predictable conditions such as temperature, humidity and air pressure. In such cases, the closed environment is typically in a box (FIG. 1, 4) with at least one flexible side (5) allowing for the controlled motion of the pipette (1), pipes (2) or parts thereof.

In some embodiments, the device includes a temperature control mechanism (3) that can be placed on top or around of the pipette (1) or pipes (2). Such temperature control mechanism can include among others temperature sensors such as thermocouples, Infra-Red sensors, negative temperature coefficient (NTC) devices and others, and heating mechanisms such as Joule heaters, magnetic heaters, induction heaters and others. In some embodiments the temperature control mechanism (3) encompasses the internal flow tubes (1,2). In some embodiments the temperature control mechanism has an internal component inside the flow tubes (1,2) for example to conduct heat via induction heating. In some embodiments the temperature control is performed in the electrolyte reservoir (not depicted).

In some embodiments, aforementioned at least one means for deposition rate assessment is a physical sensor detecting in real-time, near real-time or performing detection off-line for later assessment of deposition rates. The physical sensor can be a reflectance-based sensor, typically requiring two components for transmittance (FIG. 2, 9) and for receiving (10). Wherein the transmittance can be for example, a laser, a laser diode or another light source, and the receiving component can be for example a lens, a photodiode, a photodiode array, a CCD, any combination thereof or another known means for measuring electromagnetic radiation amplitude, location, phase, time of flight or frequency.

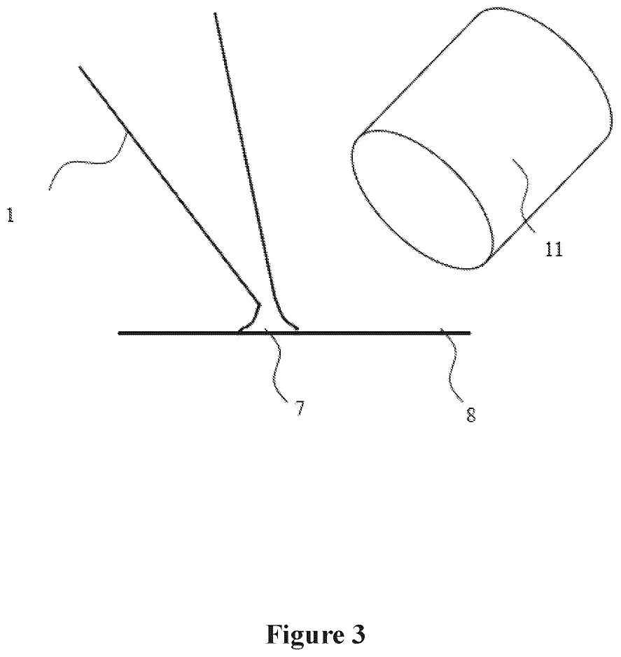

In some embodiments, the at least one means for deposition rate assessment is located on a single side (FIG. 3, 11) and can be for example a capacitance or inductance sensor, a single sided reflectance sensor or others.

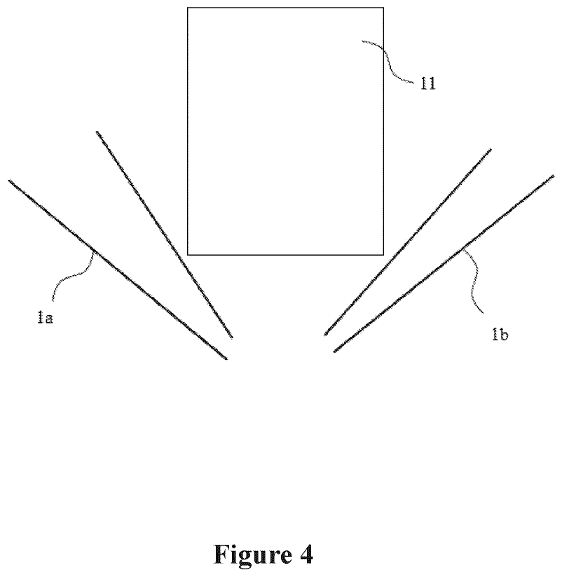

In some embodiments, the mechanical configuration is such that at least one pipette is tilted away (FIGS. 4, 1a and 1b) from the at least one means for deposition rate assessment to allow for free traversal of the radiation in use. In said embodiments, the sensors in use (11) will typically be single sided one such as capacitive and inductive sensors, astigmatism based optical sensing, ultrasound transducers and others.

In some embodiments, the contraption for additive manufacturing is placed on shock absorbers or other means to reduce unwanted motion that can hamper the resolution or accuracy of motion (FIG. 1, 6). Such means include, yet are not limited to, dynamic vibration absorbers, tuned mass dampers, active magnetic dampers, large masses, elastic materials and others. Typically, shock or vibration absorbing mechanisms will be connected to the entire contraption, to the motion control mechanism or to the wafer (8) on which the deposition occurs.

In some embodiments, laser sensors can be used to provide accurate measurement of the deposited height. Since metals deposited tend to have a far higher reflectance in the optical spectrum as well as the infra-red spectrum when compared to water, electrolytes, other salt solutions, ionic liquids, molten salts, air, humidity and other materials that might be present between a sensor positioned in the vicinity of a pipette tip and the deposited metal, a laser beam emitted from a nearby sensor will tend to be reflected from the metal. Reflected light can be resolved into assessing the deposition rate or the current height of deposited material by measuring time-of-flight, resolving phase by means of interferometry, low coherence interferometry, angle resolved low coherence interferometry, focal changes, change in reflection shape through an astigmatism lens or others. The use of laser sensors can be by a stationary beam, a scanning beam, confocal methods, scanning confocal methods, utilizing changes in focal point or any other usable technique. The laser can be emitted from an optical fiber; the reflectance can be recorded through an optical fiber or any combination thereof. In using optical fibers, the emitting element can be left away from the deposition area, for example for the purpose of preserving the integrity of expensive systems by setting them away from corrosive materials. The laser can be generated from any laser source such as a laser light emitting diode (LED), Nd:YAG, HeNe, CO₂ lasers and others using solid state, gas, dye or other technologies. Laser frequency can be manipulated by introducing non-linear components such as second harmonic generation crystals, third harmonic generation materials and so forth. The laser can be operated in pulses or as continuous wave (CW). The laser spot size can be dictated by the emitter size, by the optical fiber, by the changes due to the focal point, by lenses on the optical path, by the use of one or more collimators or by combinations thereof. By dictating a smaller spot size, higher spatial resolution can be achieved by reducing clutter and other noise from the surrounding wafer. In some embodiments, the laser is emitted from an emitters array, where different phases are introduced and allow beam forming to steer the emitted light. In some embodiments, the motion of the deposited surface is detected through the Doppler shift in emitted light on it due to its effective velocity as a rising surface.

In other embodiments, the laser sensing can be done from the side, rather than the top of the deposited material, thus assessing the length deposited rather than the thickness (meaning the same measure, but from a different orientation). To elaborate only some of the techniques mentioned above in this context, this can be done using an optical fiber, a light emitting diode or others. The measurement can be of the reflected light or of the transmitted light that tends to decay in amplitude as more material is deposited with a tendency to reflect or absorb the emitted light.

In other embodiments, an ultrasonic measurement device can be used to assess the thickness of deposited material. By measuring from the electrolyte's side, an ultrasonic transducer can measure the liquid thickness, and conversely, an ultrasonic transducer on the metallic side can measure the reflected ultrasonic waves within the metal and resolve the thickness of the metal. Typical ultrasonic frequencies for achieving high resolution in the thickness measurement are above about 20 MHz, to reflect wavelengths of tens of micrometers in water, in which the typical speed of sound is about 1,500 meters per second. The ultrasonic measurement can be performed using a piezoelectric crystal, a capacitive micromachined transducer (cMUT), a piezo micromachined transducer (pMUT) or other ultrasound transducers. In some embodiments the ultrasound measurement is used to assess the deposition rate by monitoring hydrogen generation or other bubbles and potential cavitation that might appear during the process.

In other embodiments, a capacitive sensor is used, detecting the edge of the deposited material by the change in capacitance of the air, electrolyte or another material between the sensor and the deposited end. Alternatively, an inductive transducer can be used to detect the change in a magnetic field due to the presence of ferromagnetic or non-ferromagnetic metals.

In other embodiments, differential transformer based linear or rotary measurements (LVDT or RVDT) are introduced to assess the position of the deposited material by measuring the deflection of the metal through contact with it, through the deflection of the pipette upwards, through the deflection of the pipette towards the side, or otherwise without any contact, in a similar way to inductive sensors above.

Contact-less or contact-based sensing can also be applied to the pipette itself, or to other mechanical parts of the contraption, thus used as a deposition rate sensor indirectly by measuring deflection, and more specifically due to the pipette typical high elasticity given its narrow dimensions. This measurement can be done in all abovementioned embodiments and in addition by introducing such components to simplify the measurement, increase the sound to noise ratio on acquired signals or allow the use of cheaper devices. Among others, color dyes, fluorescent materials or markers can be introduced for optical, infra-red or ultra-violet measurement. Retro-reflecting elements or materials may be introduced for the spectrum ranges mentioned, magnetic materials may be introduced, deposited by different means, metallic materials may be introduced deposited by different means, engraving may be introduced by etching, laser machining or other to create reflectance, absorption or other phenomena easy to monitor for the sake of assessing deflection and position.

In some embodiments the at least one deposition rate assessment means is an optical microscope using either single lenses or multiple lenses for stereoscopic measurement of both the deposition rate, and potentially the entire added structure.

In addition to the description above, in some embodiments, laser measurement can be used to assess 3-dimensional structures in such methods as optical coherence tomography (OCT) by resolving reflected phases. Further to this, laser or other light sources can be used to assess the shape of the meniscus outside of the pipette, in such a way that is indicative of the deposited thickness, the deposition rate or other relevant parameters.

Among others, to measure the meniscus shape, dyes of different types can be used such as fluorescent dyes, color dyes, beads, dyed beads and others. The imagery can be taken with a camera, a microscope, lasers and photodiodes, or otherwise. A laser can also be used for indirect thickness measurement by utilizing the photo-acoustic effect though emitting a high-power, low-energy laser pulse and measuring the acoustic and ultrasonic response indicative of either the electrolyte heating or the metal heating, and consequently expanding and causing an acoustic or ultrasonic detectable effect. Similarly, the introduction of laser light can be used through means of the photoelectric effect, by changing the charge of the metal target or by causing an electric voltage that can be indicative of the deposited material amount.

In other embodiments, a light source is emitting light or is channeled in such a way that the deposited structure casts a shadow that can be detected by one of abovementioned means such as photodiodes, CCDs, cameras etc.

In different embodiments, contact measurements are used to assess or measure directly the deposited materials' thickness. Such measurements can include contact measurement via an electric circuit that detects changes in electrical conductivity or the presence of a physical galvanic connection. In such embodiments, pins or wires of known positions in reference to the pipette tip can be introduced to the printing head, in such a way that a deposited metal short-circuits an electrical system in a detectable way.

Alternatively, even without a short-circuit, changes can be measured by measuring the change of conductivity over a known length. The components for this measurement can be made of such metals that tend not to allow deposition or adhesion on them such as tungsten, or alternatively, the system can be electrically disconnected or mechanically displaced during the electro-deposition process itself for example by electronically switch between an electrodeposition power supply and an electrical resistance measurement circuit. In other contact measuring embodiments, the measurement is performed through the pipette and the deposition is done around the contact sensor. In some embodiments, the electrical resistance measurement circuit can be a potentiostat or galvanostat.

In other embodiments, the at least one rate assessment means can be indirect sensing by the measurement of the wafer or target on which the material is deposited. For example, the measurement of deposited weight by means of extremely sensitive weight sensors such as Quartz Crystal Microbalances (QCMs) can be applied, with or without trimming excess weight that needs to be neglected due to the wafer weight, the electrolyte weight or the pipette weight including the fluids typically in it. Alternatively, the change in weight distribution and shape can be detected through a change in vibrational patterns of the wafer by monitoring the resonant frequency or spectral response directly (and not through a QCM). Among others, all abovementioned sensing techniques can be applied through high frequency sampling to monitor vibrations and analyze resulting spectra. The vibrations can be naturally occurring or initiated by some mechanical actuation mechanism or other.

In a different embodiment, the information regarding deposition rate can be deduced by dividing the pipette into multiple pipettes (at least one depositing pipette and at least one control pipette), in which some of them recreate the exact conditions in terms of environment and electrochemistry. In such embodiments, local high accuracy weight measurement can be used such as QCMs, highly accurate load cells etc.

In other embodiment, prior accumulated knowledge is used to assess the deposition rate given a variety of environmental sensors such as temperature sensing, humidity sensing, vibration sensing, and potentially using one or more electrochemical sensing devices including a potentiostat, current measuring, mixing measuring, hydrogen generation measurement, pH measurement and others. In some embodiments abovementioned sensors and techniques are used in conjunction with machine learning algorithms and past experience as training sets through supervised learning techniques such as neural networks, convolutional neural networks, deep neural networks, support vector machines, regression and others, or through reinforcement learning technique such as actor-critic neural networks configurations, as well as unsupervised learning techniques such as clustering. All these can result in a semi manual operation using some additional knowledge or a fully automated apparatus in which the real time sensing is translated into changes in mechanical position, in electrical parameters, in hydrodynamic parameters such as pump pressures and flow, any combination thereof or others.

In this context, or independent of it, the controller and computers are typically connected to, and allowing for the system operation, can be connected to remote databases for data sharing, software updates, usage of remote data etc. In the preferred embodiment, data from different systems is transferred via some remote connection such as internet protocol to a “cloud” remote server. The data is used for further calibration of machine learning algorithms, for results benchmarking, predictive maintenance or for general data management.

All abovementioned sensors may be used continuously during the deposition process, intermittently, in such a way that the deposition process is paused to allow measurement, yet the mechanical contraption is not moved away, or in a manner that includes some mechanical change such that the measurement can be performed unobstructed.

In some embodiments, a camera of sorts, with or without microscopy optical capabilities is used in conjunction with the measurement methods described to check for mistakes, simplify the system operation and allow further measurement. More specifically, it can be used to validate that the meniscus is touching the target surface.

In other embodiments, passive or active nuclear sensors are used for monitoring the resulting deposition. Such nuclear sensors can include a nuclear radiation source such as a gamma ray source, beta ray source or a less likely alpha ray source, as well as an x-ray source, and a nuclear detector that is typically placed on the other side, thus effectively measuring the thickness deposited from either top to bottom or from side to side. The measurement can also be based on refracted, reflected or scattered nuclear radiation particles given the material that is deposited and type of sensor. In some embodiments, the material deposited is made of or carries some nuclear emitting particles and can thus be detected using nuclear sensors. In such embodiments, the detection can be used to assess the amount of material deposited so far, for example by using prior knowledge or measurement of the emitted power or rate from the deposited material.

Among the advantages of the invention herein is the ability to measure remotely or via a relatively cheap and simple sensor. In some embodiments, said advantages are used for the integration of the system in a confined volume that allows control of environmental characteristics. Such a closed environment can be a glovebox (FIG. 1, 4, 5) enabling the use of an operator's hands while maintaining the volume sealed for external disturbances or leaks from the inside towards the surroundings. In the preferred embodiment, the confined volume is a relatively small one of the order of about 0.1 to about 30 cm in horizontal dimensions and in height.

In the preferred embodiment, 5 sides of said volume are typically rigid walls (FIG. 1, 4) that give mechanical integrity to the contraption or box. Typically, the 6th side (5) of the resulting box is made of a flexible material, thus allowing sealing of the internal volume while enabling the insertion of a moving mechanical element that goes in a through-hole in said flexible side. The mechanical element going into the box is typically a pipe (2) holding at least one component such as a fluid channel carrying electrolyte for meniscus confined deposition.

In the preferred embodiment, the ingoing pipe holds a fluid channel that goes into the confined box, and is connected on its other side to an electrolyte reservoir and to a pump. Thus, the pump can force fluid flow in either direction, towards the sealed box, in which there is typically a pipette (FIG. 1, 1) for meniscus confined electrodeposition, and towards the electrolyte reservoir in the opposite direction, potentially to refresh the concentration of ions or other materials in the electrolyte in the pipette. In some embodiments, a pump is used, wherein multiple valves allow choice between different electrolytes, and hence the electrolytes can be pumped back and forth, thus allowing multiple different metals to be deposited in layers or by the mixing of multiple electrolytes in the pipette itself or in a designated reservoir for mixing.

The pumping and valves are typically computerized to allow automatic control and to prevent errors in electrolyte choosing. The pumps in use can be microfluidic pumps, membrane pumps, rotary pumps, syringe pumps, vacuum pumps for under-pressure pulling or can utilize manual components such as an operator pressing or pulling a syringe or another device. Said pumping can be used in conjunction with flow sensors, encoders, fluid level sensors and other means to measure and validate the amount and location of a fluid.

The sealing of the flexible side (FIG. 1, 5) of the confined volume can be done using any common sealing technique or other, and among others includes sealing with shrink-fit elements, with sealants such as silicone, adhesives, epoxies, room-temperature-vulcanizing sealants (RTVs), water-based sealants like latex, mechanical pressure such as zip-ties and cable-ties, thermal bonding, soldering, welding or other.

In different embodiments, said sealed box (FIG. 1, 4, 5) can be equipped with sensors to monitor and control environmental conditions such as humidity, temperature, inert fluid concentration, alert for leaks, control pressure that can be an over-pressure or an under-pressure when compared to the ambient atmospheric one and more. In some embodiments, the humidity is forced to be high to prevent evaporation of the meniscus or liquids in the pipette. Control over meniscus size and evaporation prevention can be directly translated to improved horizontal plane resolution and also to prevent galvanic disconnects due to the meniscus reducing in size over the height axis.

In the preferred embodiment, and especially in order to enable the use of some ionic liquids or molten salts, temperature may be controlled in the sealed volume as a whole. In said embodiments, there is typically a heating element placed inside the sealed volume that can be used in conjunction with temperature sensors of different types, controllers and logic schemes, cooling elements, convection elements, venting and so forth.

In other embodiments for the sealed volume (FIG. 1, 4), the volume mentioned can be larger, and contain the entire robotic system, with or without said components such as a pump and, voltage or current source and controllers. In such cases, the entire robotic elements can be confined within the sealed box and will typically be accompanied with some airlock to allow insertion of new materials, wafers, electrolyte loading, pipette switching and so forth. In such cases maintenance can be performed through typical glovebox compartments. The entire volume can be confined in a tent-like fashion by using multiple sides that are flexible, as opposed to rigid walls.

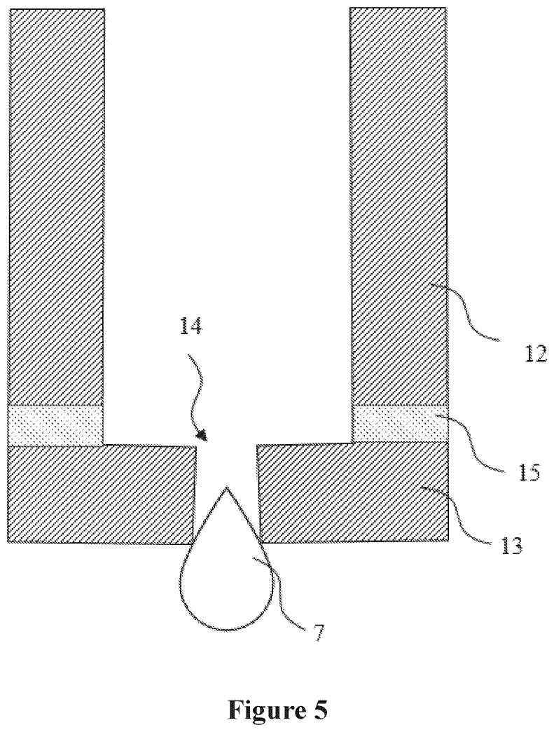

In the preferred embodiment, the deposition is performed through a pipette that is typically leading the fluid to an orifice of a low inner diameter such as about 0.25 to about 50 micrometers. In some embodiments, the pipette (FIG. 1, 1) is of a low inner diameter but with a relatively large outer diameter (FIG. 5, 12-15) which is useful to gain mechanical strength and integrity to the pipette, thus preventing fracture and allow higher pressures when touching the deposition surface. In said embodiments, when using a relatively thick pipette (12,13) (while maintaining a relatively small inner diameter (14) of the exiting channel and thus the meniscus), the pipette can be made by pulling a glass capillary, by laser drilling a hole (14) to allow exit of a droplet or meniscus (7) from the glass cylinder (12), by the combination of a cap (13) in which the exit channel was dry etched, wet-etched, mechanically drilled, laser drilled or otherwise, and the said element is connected with another component, which typically has a wider channel in it. The two components, meaning the wide tube (12) and the cap (13) can be then connected through a connecting mechanism (15) mechanically, adhered to each other, welded with laser or e-beam welding or other. In some embodiments either one or both mentioned components, or a single component can be manufactured with 3d printing with such techniques as additive manufacturing or laser sintering. In other embodiments, two photon printing or direct laser writing can be used to achieve such resolutions in the manufacturing process of the pipette.

In other embodiments, the hollow tube (FIG. 5, 12) is made of other materials such as plastics, ceramics or metals. In embodiments in which the hollow tube is made of a conductive material, it can be used in the electrochemical process as an electrode.

The system can utilize a calibration process to account for manufacturing tolerances of the pipettes. Such calibration can be performed in-situ, by a user, or in a factory or a central facility with some way of documentation and data transfer of the calibration data needed.

In some embodiments, the system utilizes a plurality of pipettes of different sizes (e.g. FIG. 4, 1a, 1b), a single pipette with collimation of the orifice that allows control of the pipette exit-hole size, or any combination thereof.

The pipette can be surface-treated with different materials and techniques to improve surface properties such as wetting properties. For example, glass pipettes can be treated to be more hydrophobic by the introduction of silicone oils or other hydrophobic materials. Glass surfaces can be treated with Siloxane attached molecules for spontaneous adhesion, with or without plasma treatment of the surface or another chemical means of activation, and following such cover, as a single step or as a further step, hydrophobic molecules can be attached. In such a case, the hydrophobic coating can aid in keeping the meniscus confinement to a desired volume or area, even in the presence of a wider pipette that might smear it towards the sides. In other embodiments, hydrophobic coating can be introduced with lipid covering, liposome or micelle covering, PVD or CVD techniques such as sputtering or others for metallic, ceramic, polymeric or other coating. In other embodiments, hydrophilic coatings are introduced to change the wetting angle in the opposite fashion.

Other coatings can be used as well in order to increase the pipette mechanical strength, prevent fracture and breaking, prevent glass, metal or plastic corrosion, etching or other chemical reactions. The pipette can otherwise be made in other embodiments of plastic materials, ceramic materials, and low conductivity metallic materials. In some embodiments, the pipette can be made as flexible as possible to allow measurement of sideways deflection as mentioned above, and to prevent fracture.

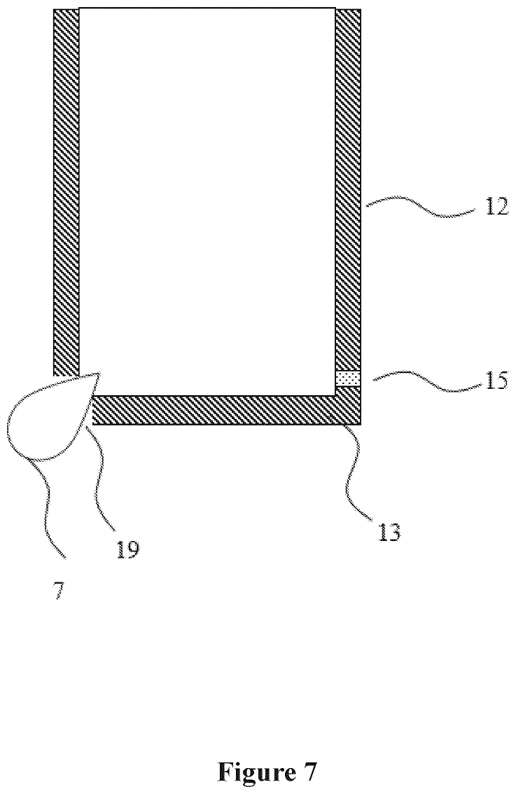

The pipette fluid channel is typically at its center, but can also be made to be at one of the sides (FIG. 7, 19), in a symmetric or an asymmetric fashion. Depositing towards the side of the pipette can help in depositing on axial surfaces for such uses as micro-coils manufacturing as described below. Such pipettes are typically used in conjunction with multiple degrees of freedom control over the system to allow rotation and tilting of the pipette as described below.

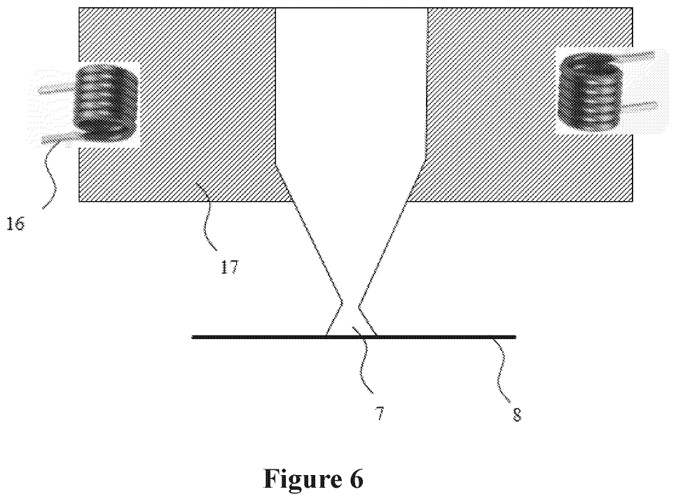

In reference to aforementioned temperature control in the sealed volume, temperature control and other environmental parameters can be controlled on the pipette itself (FIG. 1, 3). For example, such mechanisms as heating or cooling can be incorporated on the pipette, surrounding the pipette, or inside the pipette, to maintain highly accurate temperature in it. These temperature control mechanisms can be incorporated by the introduction of heating elements and temperature sensing in such ways as contactless temperature control using infrared sensors, combined with Joule heating elements, induction heating, laser heating or others, controlled by some controller. Pipette temperature setting can also use phase changing materials (PCMs, meaning materials engineered to have a desired phase transition temperature and thus maintain this temperature over time due to the latent heat required to transition between phases) that can be placed as heat and/or temperature reservoirs in contact with the pipette (FIG. 6, 17), so the temperature within the fluid in the pipette will remain constant. Due to latent heat characteristics of certain materials, such PCMs use can dictate a near-constant temperature over a long period of time given the pipette typical small dimensions and tendency to conduct, convect or radiate heat. For example, the use of distilled water can enable keeping the fluid inside a pipette at a constant about 100 degrees Centigrade while the water is evaporating and is kept at this temperature by the latent heat.

In other embodiments, PCMs can be used indirectly by their presence in the sealed volume (FIG. 6, 17) or in the vicinity of the system as explained before. The use of PCMs can also include a separate pumping system to maintain cooling or heating of the material through a reservoir by adding fluids or removing them through a vent or a valve.

In some embodiments, the pipette can be further used for mixing the at least one electrolyte with such purposes as preventing ion dilution and denigration of the electrodeposition process. As mentioned above, the mixing process can be performed by the pumping in and out of a single electrolyte to and from a reservoir of near constant concentration. It can further be performed by introducing stirring elements to the pipette such as the introduction of magnetic nano particles to the electrolyte and the rotation, vibration or other motion of a magnetic field by coils (FIG. 6, 16) that are typically external to the pipette in either a horizontal or axial array. In such embodiments magneto-hydrodynamic (MHD) effects can aid in mixing the electrolyte for different reasons.

In some embodiments the coils (FIG. 6, 16) are used for both MHD mixing of the electrolyte and for heating as mentioned above through inductive heating.

The mechanical system for accurate motion can typically use a three-dimensional accurately controlled robotic stage, which may incorporate stepper motors and gears to transmit accurate motion down to nanometer or micrometer accuracy. Such a stage can also use piezoelectric drives, capacitive based drives, stepper motors, servo motors or others. Typically, the axis aligned with gravity is dubbed the Z axis, and is moved by a single stage with such stroke distances ranging from about 0.01 to about 30 cm. This axis is typically treated separately to avoid vibration on this axis and to prevent high loads on the other two axes that might present detriment to the motion accuracy and repeatability. The other two axes are typically mounted on each other in an X-Y stage. In other embodiments, all three translation axes are mounted on each other, and in other embodiments all three are disconnected from each other. Other combination such as Y-Z mountings are also possible.

Some embodiments include additional degrees of freedom to improve the additive printing process. Some embodiments include a single angular degree of freedom for tilt at the pipette in such a way that can create more complex structures or ease the deposition process while preventing phenomena of disconnects or lack of deposition. Such angular degrees of freedom can be implemented by a piezo motor, a mounted angular servo motor or stepper motor on the moving printing head, while being connected to the piping leading the electrolyte fluid by flexible connectors. In some embodiments, two angular degrees of freedom are implemented and thus the printing head is gimballed and can assume any position over the volumetric angle. In other embodiments, a third angular degree of freedom can be implemented in addition, as a replacement of one of said degrees of freedom, or as of itself, allowing rolling the pipette around its own long axis. In such cases, the pipette can rotate around a certain point and allow the deposition sideways as mentioned above, among others for the deposition of coils.

Rolling the pipette can also allow the use of a single tilting degree of freedom and rolling to allow assumption of any position.

In other embodiments the system is inverted when compared to the typical orientation and the pipette is moved in such way that deposition is performed above it in relation to gravity. In such embodiments, there are potential advantages of filtering some undesired particulate by letting it sink against gravity and thus not be present at the deposition site.

In some embodiments, multiple pipettes are used, multiple nozzles with the same piping to it, multiple nozzles with different piping and others. Such embodiments can be used to accelerate the printing process of a single resulting goal, perform multiple parallel printings, or create multiple similar results with some desired or statistical differences between them. The multiple pipettes or nozzles can be rigidly held one in reference to the other, thus promoting identical results in different points. The pipettes or nozzles can be separately controlled in a way that allows freedom to print different things. Furthermore, multiple pipettes connected to different electrolytes can be used to print multiple different metals at more or less the same point, or at different points at approximately the same time or simultaneously. Using such an array in conjunction with tilting degrees of freedom mentioned earlier can allow the three-dimensional printing of complex shapes without the need for support materials (meaning added materials that are later taken out by some process of washing, removing, developing etching or melting). In some embodiments, the tilting angle of all pipettes is controlled centrally in reference to a single central axis, thus making sure that all or most of them point at a single line or a single point without overly complex mechanical elements for separate control.

In some embodiments, the use of printing support material with similar techniques allows to build more complex shapes without the risk of shapes collapsing during the printing process. Said support material can be any material the can be electrodeposited using the variation of the electrolyte or the electric parameters in use. Said support materials typically allow their removal from the desired printed resulted by thermal or chemical means. For example, the electrodeposition of Indium or Gallium allows increasing the temperature of the resulting printed component during or after the printing process, to melt the supporting materials in such temperatures, e.g., about 140 degrees centigrade or about 36 degrees centigrade respectively. Alternatively, using such materials as Aluminum allow their chemical removal by means like Sodium Hydroxide etching, Zinc allows removal by Sulfuric acid solutions or others. The removal process can be assisted by typical means such as sonication in a bath, mechanical peeling, temperature swings and others. In some cases, diffusion between the two metals (support material and the desired metal for deposition) can cause harm to the structural integrity of the material. In such cases, different solutions such as increasing the width of the desired metal in order for later polishing of said added material to reach the goal dimensions.

In other embodiments, support materials are deposited and removed through a different oxidation temperature or other conditions to allow the oxidizing of one metal and then its removal in its oxide form such as copper that tends to react with oxygen at temperatures as low as about 200 degrees Celsius or Tin that tends to oxidize at temperatures as low as about 150 degrees Celsius, as opposed for example to Tungsten that tends to oxidize at temperatures of above about 600 degrees Celsius. Oxidation steps typically follow by a chemical etching step.

As a direct benefit from the use of a sealed volume for the deposition area, as well as the potential use of temperature control, the invention herein allows for safer and simpler use of ionic liquids and molten salts. The use of non-aqueous solutions opens options for 3D printing metals that would otherwise be limited by the salt solubility or electrochemical characteristics of desired metals. To give some examples, yet in no way limiting the potential uses, using AlCl3-EtMeImCl (aluminum chloride-1-ethyl-3-methylimidazolium chloride) was studied as a potential medium for Titanium electrodeposition when used at temperatures close to about 100 degrees centigrade ([11]); using more classical ionic liquids in the sense of room temperature liquids such as [EMIm]Tf₂N (1-ethyl-3-methylimidazolium bis(trifluoro methylsulfonyl)amide), [BMP]Tf₂N (1-butyl-1-methyl pyrrolidinium bis(trifluoro methylsulfonyl)amide) or [P14,6,6,6]Tf₂N (trihexyltetradecyl-phosphonium bis(trifluoro methylsulfonyl)amide) for the electrodeposition of Titanium or its alloys from different salts such as halides ([12]) as well as [Bmim]BTA (1-methyl-3-butyl-imidazolium bis(trifluoro-methylsulfone)imide) or [Bmim]Tf₂N (1-butyl-3-methylimidazolium bis((trifluoro-meth-yl) sulfonyl)amide) ([13]); The use of Choline Chlorides for the deposition of Lead and its alloys ([14]). The use of [EMIm]Cl (1-ethyl-3-methylimidazolium chloride) for the deposition of aluminum and its alloys ([15]). The use of [BMIm]Cl/AlCl₃ (3-butyl-1-ethylimidazolium tetrachloroaluminate) for aluminum electrodeposition. The use of [EMIM][DCA] (1-ethyl-3-=methylimidizolium dicyanamide) at temperatures of above about 110 degrees centigrade for the deposition of Neodymium alloys, and specifically ferrous alloys that can serve as magnets ([16]). The use of HTf₂N (N,Nbis(trifluoromethylsulfonyl)imide) for deposition of Samarium and its alloys including Samarium Cobalt and Samarium Copper for their use as magnets.

In addition to the use of a variety of electrolytes as described above, additional materials can be incorporated in the solutions to alter physical or chemical characteristic and to thus improve or accelerate the printing process. For example, typically non-ionic surfactants such as Polyethylene Glycol (PEG) can be used to change both wetting angles in the meniscus as well as electrodeposition processes due, for example to changes in entropy in the liquid. Further non-ionic surfactants examples include Ethoxylated alcohols, fatty acid esters and others. Anionic or cationic surfactants can also be used in some embodiments, though require to avoid detrimental effects on the electrodeposition process itself.

In some embodiments, additional materials are added to the electrolyte to stabilize the deposition process, limit hydrogen evolution, increase rate or control the exact ions being deposited. Among others complexing agents can be added such as citrates, pyrophosphates, tartrates, gluconates, cyanides and others.

Other materials can be added to the electrolyte include nanoparticles to be immersed in the deposited surface, for example with the purpose of creating composite materials, magnetic materials, heat treating the resulting material later to create alloys with the added particulate and others. For example, the use of titanium powder can allow creating such alloys as Nickel-Titanium alloys even through the electrodeposition of Nickel in an aqueous solution. Somewhat similarly, the printing process can be performed into a powder, in such a way that the pipette is inserted into a vessel full of powder (‘a powder bath’) and is moved freely by virtue of the powder density or with the aid of vibrations to the bath itself by such mechanism as a fluidized powder bath through pressure increases, gas flows through the powder bad or vibrational actuation, applied to the bath, to the pipette or to both.

In other embodiments, organic solvents are added to an aqueous solution or are used in their pure form. Some examples include Ethanol, Methanol, Isopropanol, DMSO, Benzene, Toluene and other organic fluids. In other embodiments, the use of emulsifiers to create an emulsion for the same purposes as mentioned for organic solvents or surfactants can be used. Hexadecane is one example of such an emulsifier.

The substrate on which the deposition is performed can be pre-treated to aid in the deposition process by introducing coatings to change the wetting angle of the meniscus, prevent, limit or augment adhesion to the surface, introduce higher or lower electrical conductivity or add required components for further use such as electrodes.

The surface may include patterning or a seeding layer which typically increases the probability of depositing the base of the printed result on relatively small surface area which later allows the accurate disconnection from the substrate in order to use the result as a separate component and not on the substrate itself. This can be achieved by introducing seeds such as metal nanoparticles through block-copolymer micelle nanolithography (BCML), through nanoparticle suspension evaporation, through laser patterning, electron beam patterning, lithography or other techniques. After the deposition process has ended, the resulting device can be post treated to disconnect the elements printed, for example by the use of sonication, laser cutting, heating or mechanical cutting.

The resulting printed element can be treated by heating for improved properties such as lower porosity. It may be treated with electro polishing to control the surface roughness without physical harm to the achieved resolution. It can be further laser cut into pieces.

Prior art has taught many applications of three-dimensional printing for rapid prototyping, quick repairs, custom made medical devices and others. Naming just several examples of potential applications of the invention described herein, in the field of medical devices, additive manufacturing of Nickel-Titanium alloys can be used for the rapid prototyping or the clinical 3-dimensional manufacturing of components such as stents for cardiology, neurology, gastroenterology, nephrology, ophthalmology, dentistry, or thodentry and other fields. Since Nickel Titanium is both super elastic and a shape memory alloy in certain phases and configurations, as well as biocompatible and well known in use for medical devices and implants, the ability to print complex elements of it enables a variety of useful applications. Among them are customized stents for cardiological application such as fixing congenital heart defects, implanting patient specific stents to counter the effects of aneurysms in the vascular or the cerebral systems, and customized stents and stapling devices for preforming colon treatment such as anastomosis. The use of patient specific customized stents in conjunction with high resolution imaging modalities such as CT, MRI, OCT and high frequency ultrasound, together with high resolution and accuracy in metal 3D printing of a stent allows fitting vascular sizes or other organs' sizes in such a way that reduces risks of thrombosis, inflammation, tissue rupture and so forth. Printing of Nickel Titanium as well as other metals in such high resolutions as described herein can also be used for drug eluting devices such as drug eluting stents, for example in conjunction with a thermally actuated mechanism. Such devices can also be biodegradable, such as prior art has taught iron based biodegradable stents.

Further to medical devices, the printing of small magnets, small piezoelectric crystals and other metals finds many uses in microelectromechanical systems. Printing small magnetic materials such as NdFeB, AlNiCo, SmCo and other permanent magnets, as well as simple Ni, Fe or Co ferromagnets can be used for actuation and sensing while keeping form factor small and fit into existing MEMS designs. The printing of conductive metals as described above for the use of micro-coils can also be used for energy and for motion actuation including for the use to create micro-motors based on inductive elements, in addition to, or for the replacement of more common capacitive based actuators. Printing such piezoelectric crystals as Lead Zirconate Titanate (PZT) can allow sensing in ultrasonic frequencies as well as motion control of small elements. In addition to abovementioned applications, the invention herein can be used for the connection of electronics in a way similar to current state of the art wire bonding techniques. While the invention herein is limited at rate when compared to existing methods, it allows for smaller wire bonding on a wider variety of connecting balls or other elements. Such printing as described can also be used for purposes of fixing disconnected bonds when these are found.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

### REFERENCES

[1] WO2018028000A1
[2] US20170044680A1
[3] U.S. Pat. No. 7,372,616B2
[4] US20170145584A1
[5] WO2020075173A1
[6] US20190048486A1
[7] WO2008146920A1
[8] CN104999670A
[9] U.S. Pat. No. 8,404,160B2
[10] CN109434385A
[11] Tetsuya Tsuda, Charles L. Hussey, Gery R. Stafford, B, and John E. Bonevich, Electrochemistry of Titanium and the Electrodeposition of Al—Ti Alloys in the Lewis Acidic Aluminum Chloride-1-Ethyl-3-methylimidazolium Chloride Melt, Journal of The Electrochemical Society, 150 4 C234-C243 2003.
[12] Endres, F., et al. “On the electrodeposition of titanium in ionic liquids.” Physical Chemistry Chemical Physics 10.16 (2008): 2189-2199.
[13] Cunying Xu and Yixin Hua, Electrochemical Preparation of Titanium and its Alloy in Ionic Liquid, Intech Open Science, Chapter 18 https://cdn.intechopen.com/pdfs/48468.pdf
[14] Liana Anicai, Ion Sin, Oana Brincoveanu, Stefania Costovici, Adina Cotarta, Anca Cojocaru, Marius Enachescu, Teodor Visan, Electrodeposition of lead selenide films from ionic liquids based on choline chloride, Applied Surface Science, 475, 2019, 803-812
[15] Ashraf Bakkar, Volkmar Neubert, A new method for practical electrodeposition of aluminium from ionic liquids, Electrochemistry Communications, 51, 2015, 113-116
[16] X. Xu, S. Sturm, J. Zavasnik, K. Z. Rozman, ChemElectroChem 2019, 6, 2860.
[17] Vyatskilth, A., Delalande, S., Kudo, A. et al. Additive manufacturing of 3D nano architected metals. Nat Commun 9, 593 (2018). https://doi.org/10.1038/s41467-018-03071-9
[18] Jung, V., Jung, Y. H., Pikhitsa, P. V. et al. ye-dimensional nanoprinting via charged aerosol jets. Nature 592, 54-59 (2021). https://doi.org/10.1038/s41586-021-03353-1
[19] Córdoba, R., Orús, P., Strohauer, S. et al. Ultra-fast direct growth of metallic micro- and nano-structures by focused ion beam irradiation. Sci Rep 9, 14076 (2019). https://doi.org/10.1038/s41598-019-50411-w.

1. A system for 3D printing by using meniscus-confined electrodeposition, using at least one pipette, carrying at least one electrolyte, at least one means of thickness or deposition rate assessment and at least one motion control mechanism, configured to allow the deposition of at least one deposited metal on a substrate.

2. The system of claim 1, wherein the deposition rate assessment includes at least one transmitter and at least one receiver.

3. The system of claim 2 wherein the transmitter is a light source such as a laser or a laser diode and the receiver is an optical sensor such as at least one photodiode or at least one CCD.

4. The system of claim 3 wherein the thickness or deposition rate assessment is performed by means of astigmatism correction.

5. The system of claim 3 wherein the thickness or deposition rate assessment is performed by means of interferometry.

6. The system of claim 3 wherein the thickness or deposition rate assessment is performed by means of angle change measurement.

7. The system of claim 3 wherein the thickness or deposition rate assessment is performed by means of time-of-flight measurement.

8. The system of claim 3 wherein the transmitting component is set in such a way that the deposited metal creates a shadow that is detected by the receiving component.

9. The system of claim 2 wherein the transmitter and the receiver are set on the same side or within the same mechanical component.

10. The system of claim 1 wherein the means for thickness or deposition rate assessment is a capacitive distance transducer.

11. The system of claim 1 wherein the means for thickness or deposition rate assessment is an inductive distance transducer.

12. The system of claim 1 wherein the means for thickness or deposition rate assessment is an ultrasound transducer.

13. The system of claim 1 wherein the deposition rate assessment mechanism is a contact sensor, that can be embedded in the at least one pipette.

14. The system of claim 1 wherein the deposition rate assessment mechanism is a vibration sensor.

15. The system of claim 14 wherein the vibration sensor utilizes forced vibration that are affected by the deposited material.

16. The system of claim 1 wherein the means for thickness or deposition rate assessment is a quartz crystal microbalance (QCM).

17. The system of claim 1 wherein the means for thickness or deposition rate assessment is an electrical measurement of resistance or impedance in at least one frequency.

18. The system of claim 1 wherein the means for thickness or deposition rate assessment is an optical, infra-red, near-infra-red, short-wave-infra-red or an ultra-violet detector.

19. The system of claims 1 to 18 wherein at least one additional material is added to the electrolyte for increased signal from the disclosed means for thickness or deposition rate assessment.

20. The system of claim 19 wherein the added material is a dye to increase optical or other electromagnetics contrast.

21. The system of claim 19 wherein the added material is a fluorescent material.

22. The system of claims 1 to 21 wherein a microscope or a stereoscopic microscope is also used in combination with the combination of the sensors therein.

23. The system of claims 1 to 22 wherein the signal acquired by the at least one means for thickness or deposition rate assessment is utilized by a computer controller for prediction or assessment thereof.

24. The system of claim 1 wherein the at least one means of thickness or deposition rate assessment is a computer controller, typically calibrated by data acquired by means of claims 2 to 22.

25. The system of claim 24 wherein the computer controller applies a neural network for the deposition rate assessment.

26. The system of claims 24 to 25 wherein the deposition rate assessment is performed without additional sensors in the printing process.

27. The system of claims 23-26 wherein at least some component of memory, data or computation is performed over a remote computer such as in “cloud computing” architecture.

28. The system of claim 27 wherein signals or information regarding deposition rate is transmitted to said remote computer through some communications channel such as IP protocol.

29. The system of claims 1 to 28 wherein at least a part of the system is held internally in an environment sealed to its surroundings, typically utilizing at least one means of temperature, humidity or pressure control; potential contained overpressure to prevent entry of polluting agents or dirt or potential contained under pressure to prevent leakage of toxic or corrosive materials to the outside; and means for monitoring the internal processes and conditions.

30. The system of claim 29 wherein one wall of the sealed environment is flexible to allow the at least one motion control mechanism to move while containing a part of the system sealed.

31. The system of claim 29 wherein temperature control is applied using also at least one phase change material (PCM).

32. The system of claim 29 wherein temperature and humidity control are performed through a device in physical contact with the at least one pipette.

33. The system of claim 29 wherein the sealed environment is at least partially filled with liquid for the prevention of pipette droplets or meniscus evaporation.

34. The system of claims 1 to 33 wherein the at least one pipette is a hollow, typically tapered pipe made of glass, plastic, ceramics, metals, alloys or other materials, allowing electrolyte flow towards an orifice of typical diameters of about 0.25 to about 50 micrometers, and typically containing at least one electrode in it.

35. The system of claim 34 wherein instead of a tapered shape, the pipette has a thicker diameter along most of its length and a thin orifice at its end.

36. The system of claim 35 wherein the thin orifice is laser drilled, chemically etched, plasma etched or mechanical imprinted to have said diameters.

37. The system of claims 35 to 36 wherein the pipette is composed of at least two parts, one of which is a cap, typically including the described orifice.

38. The system of claim 27 wherein the at least two components are connected together by means of chemical adherence, physical adherence, welding, laser welding, electron beam welding, mechanical shrink-fitting or others.

39. The system of claims 34 to 38 wherein the orifice is asymmetrically placed at the side of an otherwise symmetrical pipette.

40. The system of claims 34 to 39 wherein the pipette itself is asymmetrical.

41. The system of claims 34 to 40 wherein the pipette or pipettes are tilted to allow the action of the thickness or deposition rate assessment in claims 2-26.

42. The system of claims 34 to 41 wherein the pipettes are coated or otherwise surface treated to be more hydrophobic or more hydrophilic.

43. The system of claims 34 to 41 wherein multiple pipettes are used to deposit the same material.

44. The system of claims 34 to 41 wherein multiple pipettes are used to deposit different materials.

45. The system of claims 34 to 44 wherein at least one valve or computer-controlled valve is used to control the flow into at least one pipette.

46. The system of claims 34 to 44 wherein the at least one pipette has an embedded heating mechanism such as an electric heating element.

47. The system of claims 1 to 46 wherein a mechanism is applied for introducing fresh ions into the electrolyte volume near the deposition location.

48. The system of claim 47 wherein said mechanism for fresh ion introduction is a pump such as a syringe pump, rotary pump, diaphragm pump or other.

49. The system of claims 47 to 48 wherein a magnetic mixing mechanism is introduced as well or separately such as with magnetic beads and coils for the induction of magnetic fields.

50. The system of claims 1 to 49 wherein the at least one motion control mechanism is a multiple degrees of freedom stage such as an X-Y-Z stage.

51. The system of claim 50 wherein the three stages are mounted on each other.

52. The system of claim 50 wherein on of the three stages is mounted separately, such as a separate height control for the pipette and a two-dimensional control for the substrate.

53. The system of claim 50 wherein the motion control includes at least one tilting degree of freedom, such as controlling the angle of the pipette or the substrate in reference to the axis of gravity.

54. The system of claim 50 wherein the motion control includes at least one rotary degree of freedom such as controlling the azimuth of the pipette or the substrate in reference to each other.

55. The system of claims 50 to 54 wherein the motion control is performed through stepper motors.

56. The system of claims 50 to 54 wherein the motion control is performed through piezoelectric motors.

57. The system of claims 50 to 54 wherein the motion control is performed through pizeo lever amplification (PLA) actuators.

58. The system of claims 50 to 57 wherein the motion control utilizes some closed loop feedback such as strain gauges, encoders, any of the sensors described in claims 2-26 or any combination thereof.

59. The system of claims 53 to 54 wherein the system is used in conjunction with an asymmetric pipette as disclosed in claims 39 to 40.

60. The system of claims 50 to 59 wherein multiple pipettes are controlled with separate motion controllers.

61. The system of claims 50 to 60 wherein an accurate motion control mechanism is mounted on a less accurate motion control mechanism with a longer range of motion, thus allowing the combination of local high resolution and accuracy motion and large distances or volumes for printing.

62. The system of claims 1 to 61 wherein the materials deposited are at least one or any combination of the following metals: Cu, Ni, Fe, Zn, Ag, Al, Au, Pt, Co, Pd, Sn, W, Mo, Ga, In or other elemental metals.

63. The system of claims 1 to 60 wherein the materials deposited are at least one or any combination of the following alloys: NiTi, CoNiAl, CoNiGa, NiTiPd, CoNiGa, NdFeB, SmCo or other alloy materials.

64. The system of claims 1 to 60 wherein the materials deposited are or are oxidized to be at least one or any combination of PZT, GaPO₄, PbTiO₃, LiNbO₃ or other ceramic materials.

65. The system of claims 1 to 64 wherein at least one of the deposited materials serves as a ‘support’ material intended to be removed after the 3D printing process is over.

66. The system of claim 65 wherein the support material is removed via a thermal process such as Gallium or Indium.

67. The system of claim 65 wherein the support material is removed via a chemical process such as Zn or Al.

68. The system of claim 65 wherein the support material is removed via an oxidation stage before a chemical process such as Sn or Cu.

69. The system of claims 1 to 68 wherein at least one electrolyte is an aqueous solution containing ions.

70. The system of claims 1 to 68 wherein at least one electrolyte is an ionic liquid.

71. The system of claims 1 to 68 wherein at least one electrolyte is a molten salt.

72. The system of claims 68 to 71 wherein at least one surfactant is added to the electrolyte such as PEG, ethoxylated alcohols or others.

73. The system of claims 68 to 72 wherein at least one complexing agent is added to the electrolyte such as citrates, cyanides, gluconates, pyrophosphates, tartrates or others.

74. The system of claims 68 to 73 wherein at least one organic solvent is added to the electrolyte such as DMSO, Methanol, Toluene or others.

75. The system of claims 1 to 74 wherein nanoparticles are added to the electrolyte to be embedded in the deposited result.

76. The system of claims 1 to 75 wherein the at least one substrate is surface treated prior to the position with polishing, coating or patterning.

77. A method of 3D printing, characterized by one or more steps of meniscus-confined electrodepositing, using at least one pipette, carrying at least one electrolyte, utilizing at least one means of thickness or deposition rate assessment and at least one motion control mechanism, thereby enabling the deposing of at least one deposited metal on a substrate.

78. A method of 3D printing, characterized by one or more steps of meniscus-confined electrodepositing, comprising steps of (a) providing a system of claims 1 to 76; and (b) utilizing at least one means of thickness or deposition rate assessment and at least one motion control mechanism, thereby enabling the deposing of at least one deposited metal on a substrate.

79. A system a system of claims 1 to 76, wherein said system operable in a method characterized by one or more steps of meniscus-confined electrodepositing, using at least one pipette, carrying at least one electrolyte, utilizing at least one means of thickness or deposition rate assessment and at least one motion control mechanism, thereby enabling 3D deposing of at least one deposited metal on a substrate.
